(19) United States
(12) Patent Application Publication
(10) Pub. No.: US 2003/0088652 A1
(43) Pub. Date: May 8, 2003

(54) Network reconfiguration control device and network reconfiguration control method

(75) Inventor: Satoshi Takahashi, Osaka (JP)

Correspondence Address: Jack Q. Lever, Jr., McDERMOTT, WILL & EMERY, 600 Thirteenth Street, N.W., Washington, DC, 20005-3096, US

(73) Assignee: MATSUSHITA ELECTRIC INDUSTRIAL CO., LTD.

(21) Appl. No.: 10/277,886

(22) Filed: Oct. 23, 2002

(30) Foreign Application Priority Data
Nov. 7, 2001 (JP) 2001-342262

(51) Int. Cl. G06F 15/177

(52) U.S. Cl. 709/221

(57) ABSTRACT

The network reconfiguration control device of the present invention includes: reconfiguration means for, when a new node is connected to a network, configuring a new network by performing a network reconfiguration process; completion detection means for detecting whether or not the configuration of the network has been completed; counting means for keeping track of predetermined information regarding the network reconfiguration process; comparison means for comparing the predetermined information with a predetermined reference when the completion of the configuration of the network is not detected; and new connection invalidation means for invalidating the node based on the comparison result. The reconfiguration means further performs the network reconfiguration process based on the comparison result. In this way, the present invention aims to make it possible to automatically escape from the network reconfiguration process.

### BACKGROUND OF THE INVENTION

The present invention relates to a network reconfiguration control device and a network reconfiguration control method for controlling a network reconfiguration process.

FIG. 10 is a block diagram illustrating an example of a configuration of a conventional device (hereafter referred to as “node”) to which other devices can be connected via an IEEE1394 serial bus (hereinafter referred to as “bus”).

A node A illustrated in FIG. 10 includes a port a1, a port a2, a port state machine 10, and a network reconfiguration control device (main state machine) 20D.

Typically, the port state machine 10 initializes a port when detecting a connection between the port and another port via a bus, and notifies the network reconfiguration control device 20D of the connection between the ports. Moreover, the network reconfiguration control device 20D includes a network reconfiguration section 25D for performing a process called “network reconfiguration”. Specifically, the network reconfiguration process is a series of operations including bus initialization, tree identification in which a node called “root” that controls the entire network is determined, and self-ID acknowledgement in which nodes generate their self-ID packets successively starting from the node at the end and ending with the root. Furthermore, the network reconfiguration section 25D detects whether or not the network reconfiguration process has been completed normally.

FIG. 11 is a flow chart illustrating an operation of the conventional node A. Moreover, FIG. 12A and FIG. 12B are diagrams each illustrating a state of the network illustrated in FIG. 10, wherein FIG. 12A illustrates the state of the network before the connection, and FIG. 12B illustrates the state of the network after the connection.

First, a network 50 illustrated in FIG. 10 including the node A and a node B, in which the port a2 of the node A and a port b1 of the node B are connected to each other, is stable as illustrated in FIG. 12A, with the configuration of the network 50 having been completed. Then, a port c1 of a node C is newly connected to the port a1 of the node A.

In step ST100 of FIG. 11, the port state machine 10 first detects a new connection of a port to the port a1 or the port a2 of the node A. In the illustrated example, the port state machine 10 detects that the port c1 of the node C is newly connected to the port a1 of the node A. Then, the detection of the connection is notified to the network reconfiguration control device 20D. Then, the process proceeds to step ST110, and the network reconfiguration section 25D of the network reconfiguration control device 20D performs the network reconfiguration process, i.e., a series of operations including bus initialization (ST110), tree identification (ST120) and self-ID acknowledgement (ST130).

Then, the process proceeds to step ST140, and the network reconfiguration section 25D detects whether or not the network reconfiguration process has been completed. Specifically, the network reconfiguration section 25D detects whether or not the network reconfiguration process has been completed by determining whether or not self-ID packets have been generated in self-ID acknowledgement (ST130) in the network reconfiguration process. In the network reconfiguration section 25D, the series of operations including bus initialization (ST110), tree identification (ST120) and self-ID acknowledgement (ST130) is performed automatically, and usually the process ends normally. Therefore, the network reconfiguration section 25D can usually acknowledge self-ID packets generated in self-ID acknowledgement, thus detecting the completion of the reconfiguration of a new network 60 including the node A, the node B and the newly-connected node C. Note that the new network 60 is a stable network as illustrated in FIG. 12B.

In some cases, however, the network reconfiguration process from step STI 10 to step ST130 may not end normally when, for example, the connected node C is not compliant with the standard (no problem occurs if it is compliant with the standard), or the connected node C has some other instable factors. In such a case, the network reconfiguration process from step ST110 to step ST130 is repeated many times, thereby causing not only the connected node C but also the entire bus to be inoperable for communication.

In order to avoid such a problem, IEEE1394 defines a time limit called “CONFIG TIMEOUT”, which is 166.6 to 166.9 μs. If CONFIG TIMEOUT is exceeded, the process proceeds to step ST140. In step ST140, if the network reconfiguration section 25D fails to acknowledge the generation of self-ID packets and thus fails to detect the completion of the network reconfiguration process (i.e., NO in step ST140), the process once returns to a point before the start of the network reconfiguration process, i.e., to step STI 10.

Then, if the network reconfiguration process from step ST110 to step ST130 again fails to end normally, the process again returns to a point before the start of the network reconfiguration process, i.e., to step ST110. As described above, if the network reconfiguration process fails to end normally, the network reconfiguration process from step ST110 to step ST130 is repeated, and the completion of the network reconfiguration process cannot be detected.

### SUMMARY OF THE INVENTION

An object of the present invention is to provide a network reconfiguration control device with which the process can automatically escape from a network reconfiguration process if the network reconfiguration process does not end normally but is repeated after a new node is connected to a node included in a network.

Specifically, first, a network reconfiguration control device of the present invention includes: reconfiguration means for, when a new node is connected to a first network including one or more nodes, configuring a second network by performing a network reconfiguration process of acknowledging the new node; completion detection means for detecting whether or not the configuration of the second network has been completed; counting means for keeping track of predetermined information regarding the network reconfiguration process performed by the reconfiguration means; comparison means for comparing the predetermined information kept track of by the counting means with a predetermined reference when the completion of the configuration of the second network is not detected by the completion detection means; and new connection invalidation means for invalidating the newly-connected node based on the comparison result from the comparison means, wherein the reconfiguration means further performs the network reconfiguration process based on the comparison result from the comparison means.

With the network reconfiguration control device of the present invention, in a case where the network reconfiguration process does not end normally but is repeated, the predetermined information regarding the network reconfiguration process is compared with the predetermined reference, and the newly-connected node is invalidated based on the comparison result. Thus, it is possible to automatically escape from the network reconfiguration process. As a result, the state of the network can be turned back into the state of the original, normal network.

In the network reconfiguration control device, it is preferred that: the counting means keeps track of the predetermined information by counting the number of times the network reconfiguration process is performed by the reconfiguration means; the comparison means compares the number of times counted by the counting means with a predetermined number of times as the predetermined reference; the new connection invalidation means invalidates the newly-connected node when the number of times counted by the counting means exceeds the predetermined number of times; and the reconfiguration means further performs the network reconfiguration process when the number of times counted by the counting means does not exceed the predetermined number of times.

In the network reconfiguration control device, it is preferred that: the network reconfiguration control device further includes invalid connection acknowledgement means for acknowledging the node that has been invalidated by the new connection invalidation means; the counting means measures a first amount of time from the invalidation of the node by the new connection invalidation means; the comparison means further compares the first amount of time measured by the counting means with a first predetermined amount of time; and the new connection invalidation means re-validates the node that has been acknowledged by the invalid connection acknowledgement means when the first amount of time measured by the counting means exceeds the first predetermined amount of time.

In the network reconfiguration control device, it is preferred that the number of times counted by the counting means is the number of times the network reconfiguration process is performed within a predetermined amount of time.

In the network reconfiguration control device, it is preferred that the reconfiguration means further performs the network reconfiguration process not only when the number of times counted by the counting means does not exceed the predetermined number of times, but also after the node has been invalidated by the new connection invalidation means.

In the network reconfiguration control device, it is preferred that: the network reconfiguration control device further includes invalid connection acknowledgement means for acknowledging the node that has been invalidated by the new connection invalidation means; the counting means measures a first amount of time from the invalidation of the node by the new connection invalidation means; the comparison means further compares the first amount of time measured by the counting means with a first predetermined amount of time; and the new connection invalidation means re-validates the node that has been acknowledged by the invalid connection acknowledgement means when the first amount of time measured by the counting means exceeds the first predetermined amount of time.

In the network reconfiguration control device, it is preferred that the number of times counted by the counting means is the number of times the network reconfiguration process is performed within a predetermined amount of time.

In the network reconfiguration control device, it is preferred that the network reconfiguration process includes a series of operations of bus initialization, tree identification and self-ID acknowledgement.

In the network reconfiguration control device, it is preferred that the new connection invalidation means invalidates the newly-connected node by invalidating a port for the newly-connected node.

In the network reconfiguration control device, it is preferred that: the counting means keeps track of the predetermined information by measuring a second amount of time from the initiation of the network reconfiguration process by the reconfiguration means; the comparison means compares the second amount of time measured by the counting means with a second predetermined amount of time as the predetermined reference; the new connection invalidation means invalidates the newly-connected node when the second amount of time measured by the counting means exceeds the second predetermined amount of time; and the reconfiguration means further performs the network reconfiguration process when the second amount of time measured by the counting means does not exceed the second predetermined amount of time.

In the network reconfiguration control device, it is preferred that: the network reconfiguration control device further includes invalid connection acknowledgement means for acknowledging the node that has been invalidated by the new connection invalidation means; the counting means further measures a first amount of time from the invalidation of the node by the new connection invalidation means; the comparison means further compares the first amount of time measured by the counting means with a first predetermined amount of time; and the new connection invalidation means re-validates the node that has been acknowledged by the invalid connection acknowledgement means when the first amount of time measured by the counting means exceeds the first predetermined amount of time.

In the network reconfiguration control device, it is preferred that the reconfiguration means further performs the network reconfiguration process not only when the second amount of time measured by the counting means does not exceed the second predetermined amount of time, but also after the node has been invalidated by the new connection invalidation means.

Second, a network reconfiguration control method of the present invention includes: a reconfiguration step of, when a new node is connected to a first network including one or more nodes, configuring a second network by performing a network reconfiguration process of acknowledging the new node; a completion detection step of detecting whether or not the configuration of the second network has been completed; a counting step of keeping track of predetermined information regarding the network reconfiguration process performed in the reconfiguration step; a comparison step of comparing the predetermined information kept track of in the counting step with a predetermined reference when the completion of the configuration of the second network is not detected in the completion detection step; and a new connection invalidation step of invalidating the newly-connected node based on the comparison result from the comparison step, wherein in the reconfiguration step, the network reconfiguration process is further performed based on the comparison result from the comparison step.

In the network reconfiguration control method, it is preferred that: in the counting step, the predetermined information is kept track of by counting the number of times the network reconfiguration process is performed in the reconfiguration step; in the comparison step, the number of times counted in the counting step is compared with a predetermined number of times as the predetermined reference; in the new connection invalidation step, the newly-connected node is invalidated when the number of times counted in the counting step exceeds the predetermined number of times; and in the reconfiguration step, the network reconfiguration process is further performed when the number of times counted in the counting step does not exceed the predetermined number of times.

In the network reconfiguration control method, it is preferred that: the network reconfiguration control method further includes an invalid connection acknowledgement step of acknowledging the node that has been invalidated in the new connection invalidation step; in the counting step, a first amount of time from the invalidation of the node in the new connection invalidation step is measured; in the comparison step, the first amount of time measured in the counting step is further compared with a first predetermined amount of time; and the node that has been acknowledged in the invalid connection acknowledgement step is re-validated in the new connection invalidation step when the first amount of time measured in the counting step exceeds the first predetermined amount of time.

In the network reconfiguration control method, it is preferred that in the reconfiguration step, the network reconfiguration process is further performed not only when the number of times counted in the counting step does not exceed the predetermined number of times, but also after the node has been invalidated in the new connection invalidation step.

In the network reconfiguration control method, it is preferred that: in the counting step, the predetermined information is kept track of by measuring a second amount of time from the initiation of the network reconfiguration process in the reconfiguration step; in the comparison step, the second amount of time measured in the counting step is compared with a second predetermined amount of time as the predetermined reference; in the new connection invalidation step, the newly-connected node is invalidated when the second amount of time measured in the counting step exceeds the second predetermined amount of time; and in the reconfiguration step, the network reconfiguration process is further performed when the second amount of time measured in the counting step does not exceed the second predetermined amount of time.

In the network reconfiguration control method, it is preferred that: the network reconfiguration control method further includes an invalid connection acknowledgement step of acknowledging the node that has been invalidated in the new connection invalidation step; in the counting step, a first amount of time from the invalidation of the node in the new connection invalidation step is further measured; in the comparison step, the first amount of time measured in the counting step is further compared with a first predetermined amount of time; and the node that has been acknowledged in the invalid connection acknowledgement step is re-validated in the new connection invalidation step when the first amount of time measured in the counting step exceeds the first predetermined amount of time.

In the network reconfiguration control method, it is preferred that in the reconfiguration step, the network reconfiguration process is further performed not only when the second amount of time measured in the counting step does not exceed the second predetermined amount of time, but also after the node has been invalidated in the new connection invalidation step.

### BRIEF DESCRIPTION OF THE DRAWINGS

FIG. 1 is a block diagram illustrating an example of a configuration of a node including a network reconfiguration control device according to the first embodiment of the present invention.

FIG. 2 is a flow chart illustrating an operation of the node illustrated in FIG. 1.

FIG. 3A to FIG. 3C are diagrams each illustrating a state of a network.

FIG. 4 is another flow chart illustrating an operation of the node illustrated in FIG. 1.

FIG. 5 is a flow chart illustrating an operation of the node illustrated in FIG. 1 according to a variation of the first embodiment.

FIG. 6 is another flow chart illustrating an operation of the node illustrated in FIG. 1 according to a variation of the first embodiment.

FIG. 7 is a block diagram illustrating an example of a configuration of a node including a network reconfiguration control device according to the second embodiment of the present invention.

FIG. 8 is a flow chart illustrating an operation of the node illustrated in FIG. 7.

FIG. 9 is a diagram illustrating an example of a disable bit of a register of the IEEE1394 standard.

FIG. 10 is a flow chart illustrating an example of a configuration of a node including a network reconfiguration control device of a conventional example.

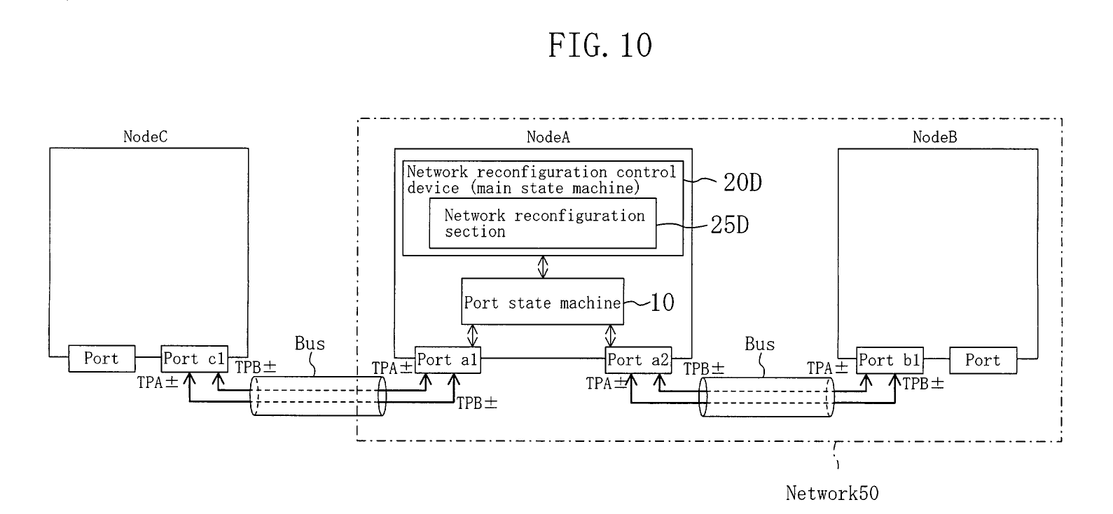

FIG. 11 is a flow chart illustrating an operation of the node of the conventional example.

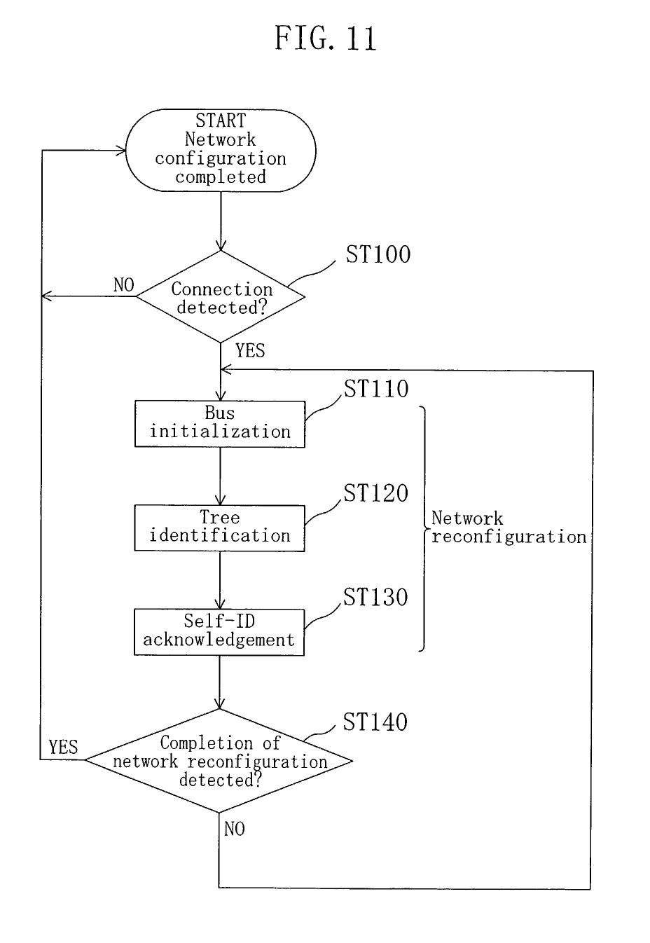

FIG. 12A and FIG. 12B are block diagrams each illustrating a state of a network of the conventional example.

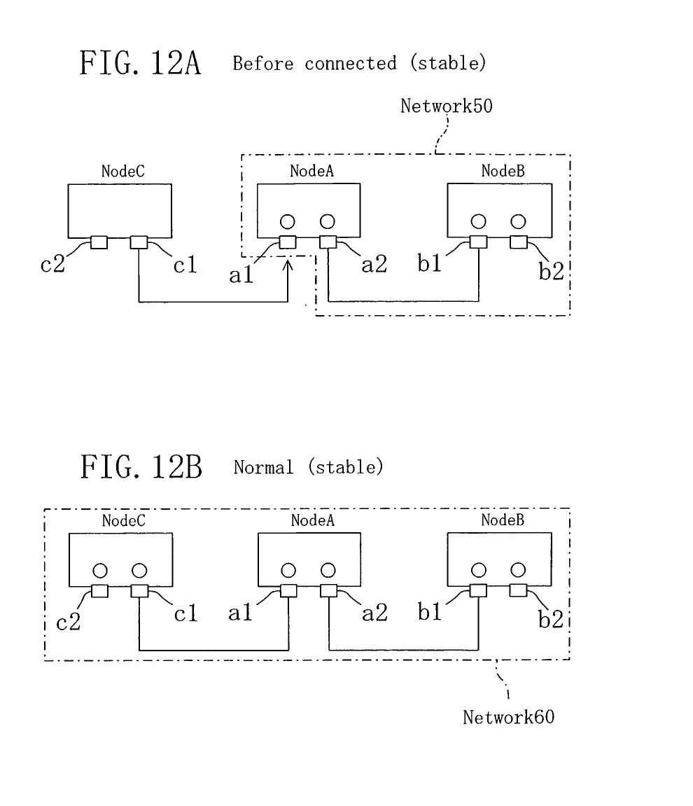

### DETAILED DESCRIPTION OF THE INVENTION

Embodiments of the present invention will now be described with reference to the drawings.

First Embodiment

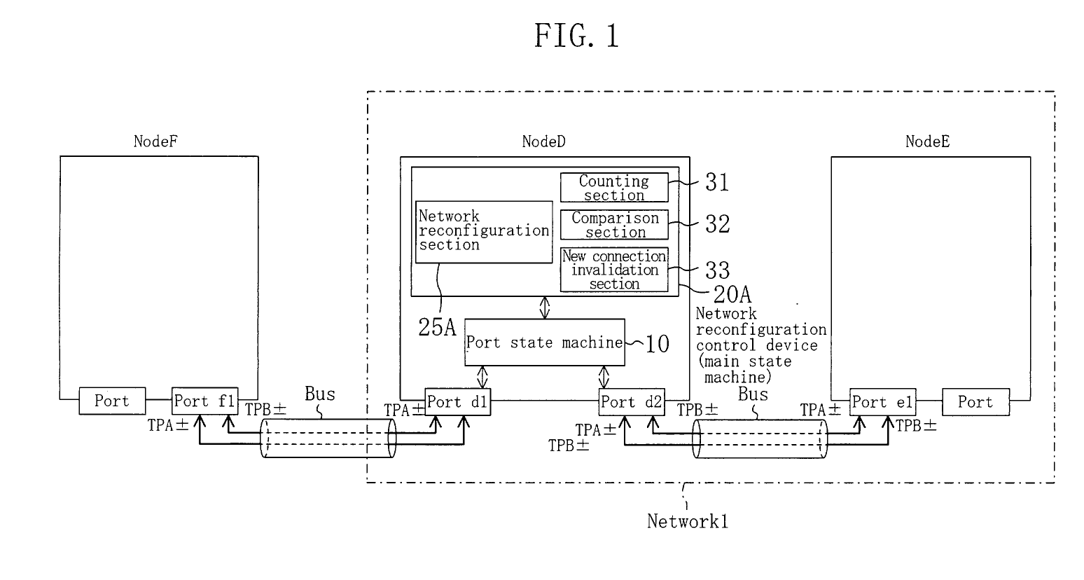

FIG. 1 is a diagram illustrating an example of a configuration of a node D including a network reconfiguration control device 20A of the present embodiment.

The network reconfiguration control device 20A will be described below assuming a case where the network reconfiguration control device 20A is implemented in the cable physical layer as defined in the IEEE1394 standard, in view of restraints of the IEEE1394 standard.

The node D illustrated in FIG. 1 includes a port d1, a port d2, a port state machine 10, and the network reconfiguration control device (main state machine) 20A.

Typically, the port state machine 10 initializes a port when detecting a connection between the port and another port via an IEEE1394 serial bus, and notifies the network reconfiguration control device 20A of the connection between the ports.

The network reconfiguration control device 20A includes a network reconfiguration section 25A, and further includes a counting section 31 (corresponding to “counting means”), a comparison section 32 (corresponding to “comparison means”), and a new connection invalidation section 33 (corresponding to “new connection invalidation means”).

The network reconfiguration section (including reconfiguration means (not shown) and completion detection means (not shown)) 25A performs the network reconfiguration process (corresponding to “reconfiguration step”), i.e., a series of operations including bus initialization, tree identification and self-ID acknowledgement. The network reconfiguration control device 20A detects whether or not the network reconfiguration process has been completed normally (corresponding to “completion detection step”).

Bus initialization is typically performed by sending a bus reset signal to each of the ports of all nodes to which another node is connected. Thus, the bus is once initialized in preparation for the reconstruction of a map, i.e., topology, of the bus connection.

Tree identification is typically performed as follows. When bus initialization is completed, the tree structure of the nodes is analyzed, and the orientation to the root node is determined for all ports to which another port is connected so as to select one node as the root.

Self-ID acknowledgement is typically performed as follows. When tree identification is completed, all nodes are made to generate their physical identifiers called “physical IDs”, i.e., self-ID packets.

Moreover, when the network reconfiguration section 25A detects that the network reconfiguration process has been completed normally, the network reconfiguration section 25A outputs a reset signal (not shown) to instruct the counting section 31 to reset the counted number of times to be described later.

The counting section 31 counts the number of times (corresponding to “predetermined information”) indicating how many times the series of operations of the network reconfiguration process is repeated within a predetermined period of time (corresponding to “counting step”). Moreover, when the counting section 31 receives a reset signal (not shown) from the network reconfiguration section 25A or the comparison section 32 to be described later, the counting section 31 resets the number of times the network reconfiguration process has been performed.

The comparison section 32 compares a predetermined number of times (corresponding to “predetermined reference”), e.g., 20, with the number of times being counted by the counting section 31 (corresponding to “comparison step”). Moreover, when the counted number of times exceeds the predetermined number of times, the comparison section 32 outputs a reset signal (not shown) to instruct the counting section 31 to reset the number of times the network reconfiguration process has been performed.

The new connection invalidation section 33 invalidates the newly-connected node based on the comparison result from the comparison section 32 (corresponding to “new connection invalidation step”). Specifically, when the number of times counted by the counting section 31 exceeds the predetermined number of times, a disable bit of the IEEE1394 standard is set so as to disable the port for the newly-connected node, thus invalidating the node.

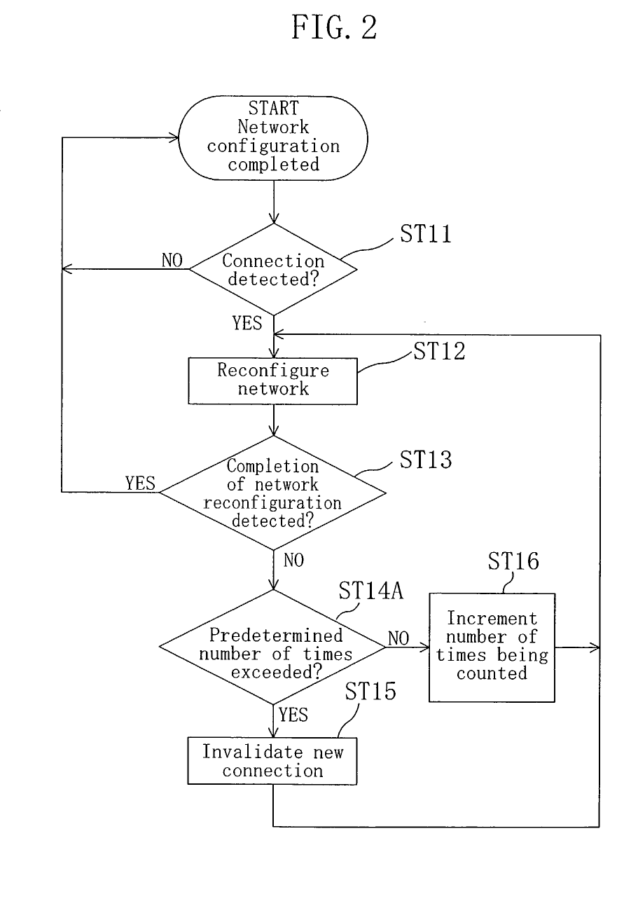

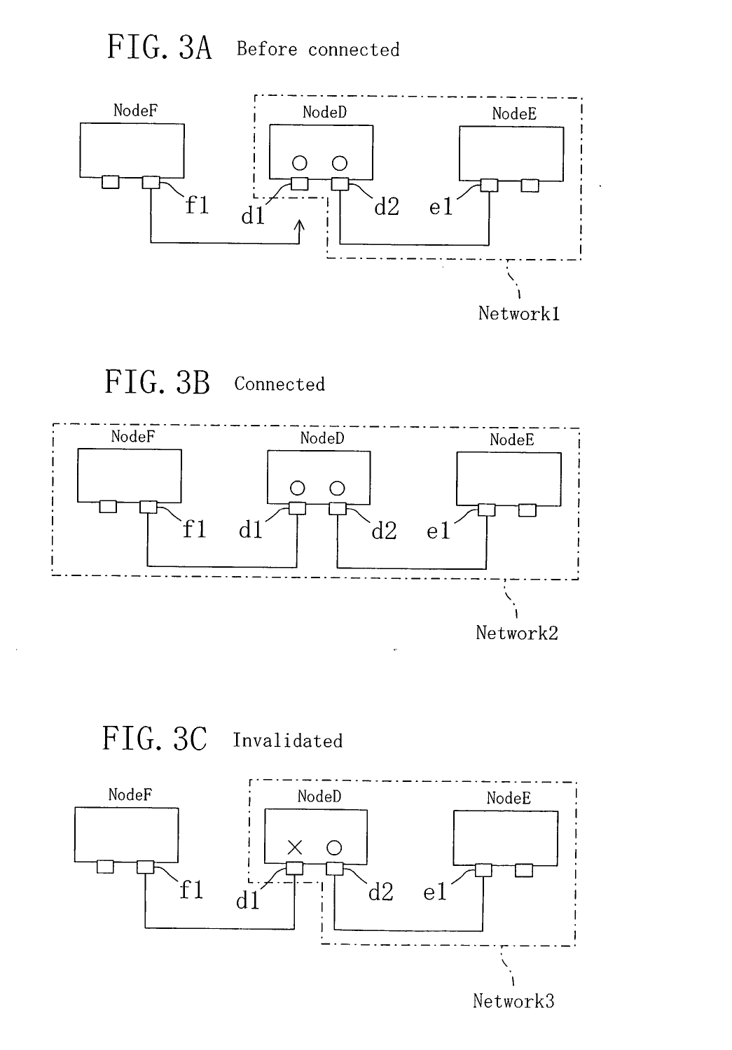

FIG. 2 is a flow chart illustrating an operation of the node D including the network reconfiguration control device 20A of the present embodiment. Moreover, FIG. 3A to FIG. 3C are diagrams each illustrating a state of a network. FIG. 3A illustrates a state of the network before a new node is connected, FIG. 3B illustrates a state of the network with the new node being connected, and FIG. 3C illustrates a state where the connection of the new node has been invalidated.

First, a network 1 (corresponding to “first network”) illustrated in FIG. 1 including the node D and a node E, in which the port d2 of the node D and a port e1 of the node E are connected to each other, is stable as illustrated in FIG. 3A, with the configuration of the network 1 having been completed. Then, in the illustrated example, a port f1 of a node F is newly connected to the port d1 of the node D.

In step ST11 of FIG. 2, the port state machine 10 first detects a new connection of a port to the port d1 and the port d2 of the node D. Specifically, the port state machine 10 determines the presence/absence of a connection by detecting the presence/absence of a bias output from TPA and TPB of a node being connected. In the illustrated example, the port state machine 10 detects that the port f1 of the node F is newly connected to the port d1 of the node D (i.e., YES in step ST11). Then, the port state machine 10 initializes the ports and, when the ports are ready for communication, sends a Port_Status signal, which is a control signal, to the network reconfiguration control device 20A.

Then, the process proceeds to step ST12. In the network reconfiguration control device 20A, which has received the Port_Status signal, the reconfiguration means in the network reconfiguration section 25A performs the network reconfiguration process as described above, i.e., a series of operations including bus initialization, tree identification and self-ID acknowledgement (corresponding to “reconfiguration step”). If the port state machine 10 fails to detect the presence/absence of a bias and to detect a new connection (i.e., NO in step ST11), the process returns to START because the network 1 remains stable.

Then, the process proceeds to step ST13, and the completion detection means in the network reconfiguration section 25A detects whether or not the network reconfiguration process has been completed normally (corresponding to “completion detection step”). In the network reconfiguration section 25A, the series of operations including bus initialization, tree identification and self-ID acknowledgement is performed automatically, and usually the process ends normally. Therefore, the network reconfiguration section 25A detects the completion of the configuration of a new network 2 (corresponding to “second network”) including the node D, the node E and the newly-connected node F (i.e., YES in step ST13). Note that the new network 2 is a stable network as illustrated in FIG. 3B, and also in such a case, the process returns to START. Moreover, when the network reconfiguration section 25A detects the completion of the configuration of the network 2, the network reconfiguration section 25A outputs a reset signal as described above to the counting section 31. When the counting section 31 receives the reset signal, the counting section 31 resets the counted number of times.

In some cases, however, the network reconfiguration process may not end normally for some instable factors such as a non-compliant device (node) being connected. In such a case, the network reconfiguration section 25A may not be able to detect the completion of the network reconfiguration process as it fails to acknowledge the generation of self-ID packets (i.e., NO in step ST13). In such a case, the process proceeds to step ST14A.

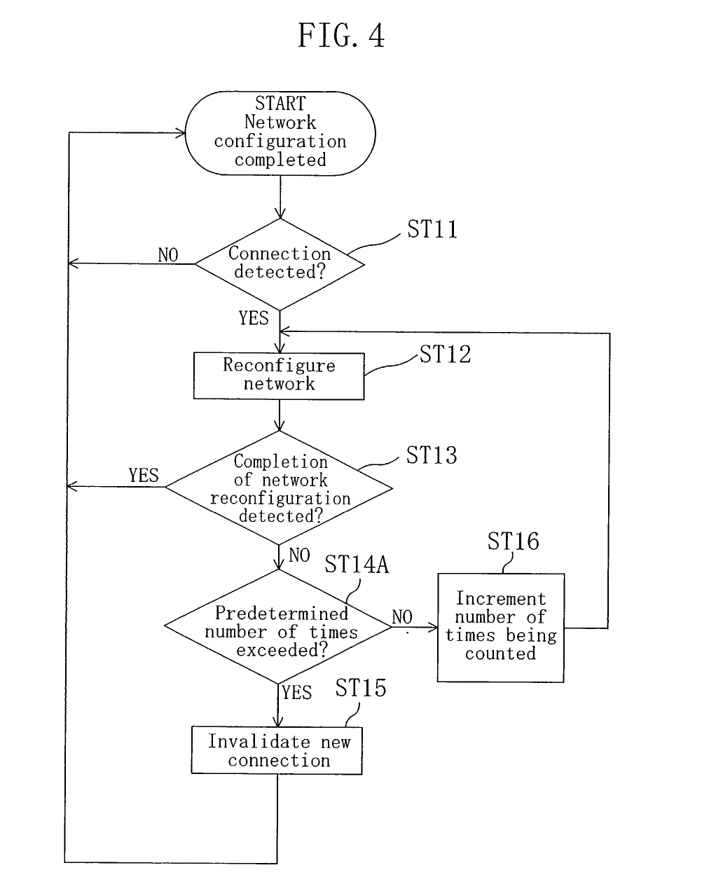

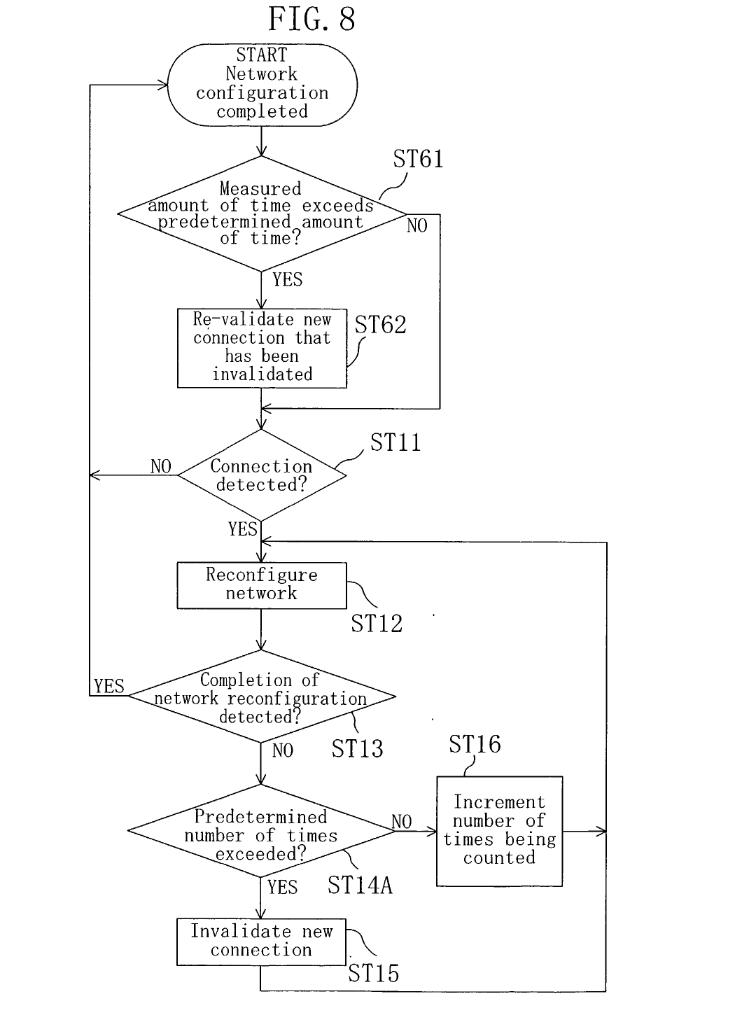

In step ST14A, first, the counting section 31 in the network reconfiguration control device 20A counts the number of times the network reconfiguration process as described above is performed (i.e., the number of times the bus is reset) within a predetermined period of time (corresponding to “counting step”). For example, the predetermined period of time may be a period of time that is greater, by a number of times, the length of CONFIG TIMEOUT, as set forth in the prior art section. Thus, by setting the predetermined period of time, it is possible to automatically prevent an erroneous disconnection if the predetermined period of time is exceeded. In the comparison section 32, the number of times being counted by the counting section 31 is compared with a predetermined number of times (corresponding to “comparison step”). If the counted number of times exceeds the predetermined number of times (i.e., YES in step S14A), the process proceeds to step ST15. Moreover, when the counted number of times exceeds the predetermined number of times, the comparison section 32 outputs a reset signal as described above to the counting section 31. When the counting section 31 receives the reset signal, the counting section 31 resets the counted number of times. On the other hand, when the predetermined number of times is not exceeded (i.e., NO in step ST14A), the counting section 31 increments the number of times and the process returns to step ST12. The operation in step ST16 may alternatively be performed by the counting section 31 in step ST14 (this also applies to the flow charts of FIG. 4 and FIG. 8).

Then, in step ST15, the new connection invalidation section 33 in the network reconfiguration control device 20A invalidates the newly-connected node F (corresponding to “new connection invalidation step”). Specifically, in a register of the IEEE1394 standard, “1” is written to a disable bit corresponding to an invalidated port, and “0” is written to a disable bit corresponding to a valid port. In the illustrated example, the port d1 of the node D is disabled by writing “1 ”to the disable bit corresponding to the port d1. In this way, the network reconfiguration control device 20A does not operate with respect to the port d1, and thus the newly-connected node F can be invalidated. Then, the process returns to step ST12.

Thus, in step ST12, the network reconfiguration process is performed for a network 3 illustrated in FIG. 3C, in which the newly-connected node F has been invalidated. Then, the process proceeds to step ST13. Since the node F has been invalidated, the state of the network 3 is substantially equal to the state of the original, stable network 1 as illustrated in FIG. 3A, and thus the completion of the network reconfiguration process is detected (i.e., YES in step S13). Then, the process returns to START. Note that the state of the network 3 is described above to be “substantially equal to” the state of the network 1, taking into consideration a possible case where the root node in the network 1 (as determined in the tree identification of the network reconfiguration process (step ST12)) is different from the root node in the network 3.

Moreover, the description above has been directed to a case where the newly-connected node F is invalidated by the new connection invalidation section 33 in step ST15, and then the process returns to step ST12 to perform the network reconfiguration process. However, the present embodiment is not limited thereto. Alternatively, after the invalidation in step ST15, the process may return to START directly, not via the network reconfiguration process in step ST12.

FIG. 4 is a flow chart illustrating such an alternative operation of the node D. Note that steps that have already been described above will not be further described below.

If the new connection invalidation section 33 invalidates the newly-connected node F in step ST15, the network 3 as illustrated in FIG. 3C is in the same state as the network 1 before the node F is connected as illustrated in FIG. 3A (with the same node being the root). Therefore, the process can return to START directly, as illustrated in FIG. 4.

Note that the description above has been directed to a case where the number of times being counted by the counting section 31 is reset by outputting a reset signal from the comparison section 32 to the counting section 31 when it is determined in step ST14A that the counted number of times exceeds a predetermined number of times (i.e., YES in step ST14A). However, the present invention is not limited thereto, and the number of times being counted by the counting section 31 may be reset alternatively by outputting a reset signal (not shown) from the new connection invalidation section 33 to the counting section 31 as described above when the new connection invalidation section 33 invalidates a newly-connected node in step ST15 to be described later.

As described above, according to the present embodiment, even if the network reconfiguration process, which is performed when a new node is connected to a network, does not end normally but is repeated due to, for example, some instable factors that the newly-connected node has, the process can automatically escape from the network reconfiguration process by invalidating the newly-connected node when a certain condition is met, which is possible through the provision of the counting section 31, the comparison section 32 and the new connection invalidation section 33. As a result, the network can be turned back into a network whose state is substantially equal to the original state of the network by performing the network reconfiguration process again. Alternatively, the network can be turned back into the original network without performing the network reconfiguration process again.

Note that the present embodiment has been directed to a case where the counting section 31 counts the number of times the network reconfiguration process is performed. However, the present embodiment is not limited thereto. For example, the counting section 31 may alternatively measure the amount of time elapsed from the initiation of bus initialization, so that whether or not to continue to perform the network reconfiguration process can be determined based on the amount of time. Since bus initialization is performed along the time axis, whether or not bus initialization has been performed normally can be easily determined by measuring the time. For example, it can be determined that the process is not normal when a bus reset signal is sent a number of times after passage of 166 μs, which is the bus initialization time specified in the IEEE1394 standard, and before passage of 330 ms, at which the next new connection is detected. Thus, bus initialization is initiated after passage of 330 ms, at which the first connection is detected, and it can be determined that the process is in an abnormal state if the network reconfiguration process is not completed within another 330 ms, i.e., before the next connection is detected.

Variation

In view of the above, in a variation of the first embodiment of the present invention to be described below, the counting section 31 measures the amount of time elapsed from the initiation of the network reconfiguration process, instead of counting the number of times the network reconfiguration process is performed.

Note that although the variation will be described below with continued reference to FIG. 1, the description will be based on what has already been described above, which will not be repeated below, and features that are characteristic of the variation will be focused on.

The network reconfiguration control device 20A illustrated in FIG. 1 includes the network reconfiguration section 25A, and further includes the counting section 31 according to the present variation (corresponding to “counting means”), the comparison section 32 according to the present variation, and the new connection invalidation section 33.

The network reconfiguration section 25A performs the network reconfiguration process as described above, and detects whether or not the network reconfiguration process has been completed normally. Furthermore, when the network reconfiguration process has been completed normally, the network reconfiguration section 25A outputs a reset signal (not shown) to instruct the counting section 31 of the present variation to reset the time being measured.

The counting section 31 of the present variation measures the amount of time for which the network reconfiguration process has been performed. Specifically, the counting section 31 receives a signal (not shown) that indicates the initiation of the network reconfiguration process (i.e., the initiation of bus initialization) from the network reconfiguration section 25A, and starts measuring the amount of time (corresponding to “second amount of time”, and also to “predetermined information”) elapsed from the initiation of the network reconfiguration process (corresponding to “counting step”). Moreover, when the counting section 31 receives a reset signal (not shown) from the network reconfiguration section 25A or the comparison section 32 of the present variation to be described later, the counting section 31 resets the amount of time measured from the initiation of the network reconfiguration process.

The comparison section 32 of the present variation compares a predetermined amount of time (corresponding to “second predetermined amount of time”, and also to “predetermined reference”) with the second amount of time being measured by the counting section 31 (corresponding to “comparison step”). When the second amount of time exceeds the second predetermined amount of time, the comparison section 32 outputs a reset signal (not shown) to instruct the counting section 31 to reset the amount of time being measured.

The new connection invalidation section 33 invalidates the newly-connected node based on the comparison result from the comparison section 32 (corresponding to “new connection invalidation step”). Specifically, when the second amount of time being measured by the counting section 31 exceeds the second predetermined amount of time, a disable bit of the IEEE1394 standard is set so as to disable the port for the newly-connected node, thus invalidating the node.

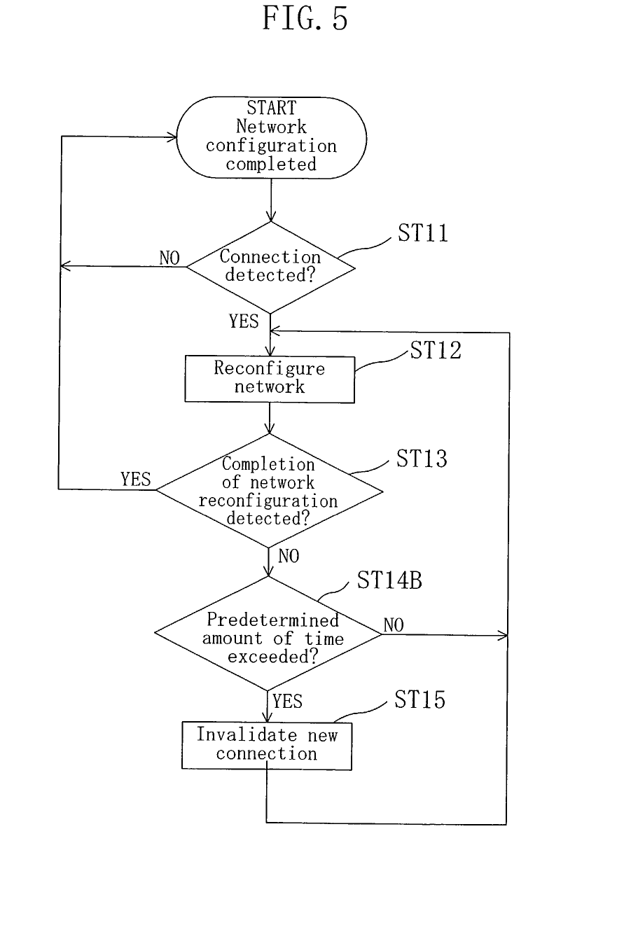

FIG. 5 is a flow chart illustrating an operation of the node D including the network reconfiguration control device 20A of the variation of the present embodiment.

The process proceeds step by step as described above with reference to FIG. 2 to reach step ST13. In step ST13, the completion detection means in the network reconfiguration section 25A detects whether or not the network reconfiguration process has been completed normally. The network reconfiguration process performed by the network reconfiguration section 25A as described above usually ends normally. Therefore, the network reconfiguration section 25A usually detects the completion of the configuration of the new network 2 (corresponding to “second network”) including the node D, the node E and the newly-connected node F (i.e., YES in step ST13). Note that the new network 2 is a stable network as illustrated in FIG. 3B, and also in such a case, the process returns to START. Moreover, when the network reconfiguration section 25A detects the completion of the configuration of the network 2, the network reconfiguration section 25A outputs a reset signal to the counting section 31, and the counting section 31 resets the second amount of time being measured.

However, also with the present variation, there are cases where the completion of the network reconfiguration process cannot be detected (i.e., NO in step ST13). In such a case, the process proceeds to step ST14B.

In step ST14B, the comparison section 32 in the network reconfiguration control device 20A compares the second amount of time elapsed from the initiation of the network reconfiguration process, which is measured by the counting section 31, with the second predetermined amount of time as described above, e.g., 330 ms. If the second amount of time exceeds the second predetermined amount of time (i.e., YES in step ST14B), the process proceeds to step ST15. Then, the comparison section 32 outputs a reset signal to the counting section 31, and the counting section 31 resets the second amount of time being measured. On the other hand, if the second predetermined amount of time is not exceeded (i.e., NO in step ST14B), the process returns to step ST12 to perform the network reconfiguration process again. Note that in such a case (i.e., No in step ST14B), the counting section 31 continues to measure the amount of time elapsed from the initiation of the network reconfiguration process.

In step ST15, the new connection invalidation section 33 in the network reconfiguration control device 20A invalidates the newly-connected node F as described above. Thereafter, the process returns to START via step ST12 and step ST13.

Also in the present variation, the process may alternatively return to START directly, not via the network reconfiguration process in step ST12, after the invalidation in step ST15.

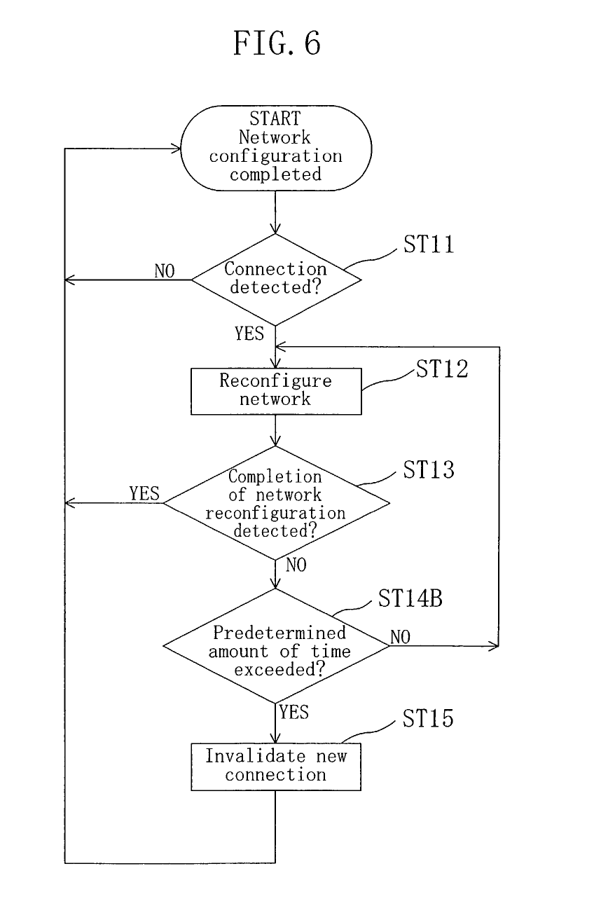

FIG. 6 is a flow chart illustrating such an alternative operation of the node D. Note that steps that have already been described above will not be further described below.

If the new connection invalidation section 33 invalidates the newly-connected node F in step ST15, the network is stable for the reason as described above. Therefore, the process can return to START directly.

Of course, also in the present variation, the amount of time being measured by the counting section 31 may be reset alternatively by outputting a reset signal from the new connection invalidation section 33 to the counting section 31 when the new connection invalidation section 33 invalidates a newly-connected node, instead of outputting the reset signal from the comparison section 32.

Thus, the variation of the present embodiment also provides the effect as described above, i.e., the process can automatically escape from the network reconfiguration process. As a result, the network can be turned back into a network whose state is substantially equal to the original state of the network by performing the network reconfiguration process again. Alternatively, the network can be turned back into the original network without performing the network reconfiguration process again.

Second Embodiment

The second embodiment of the present invention will now be described with reference to the drawings.

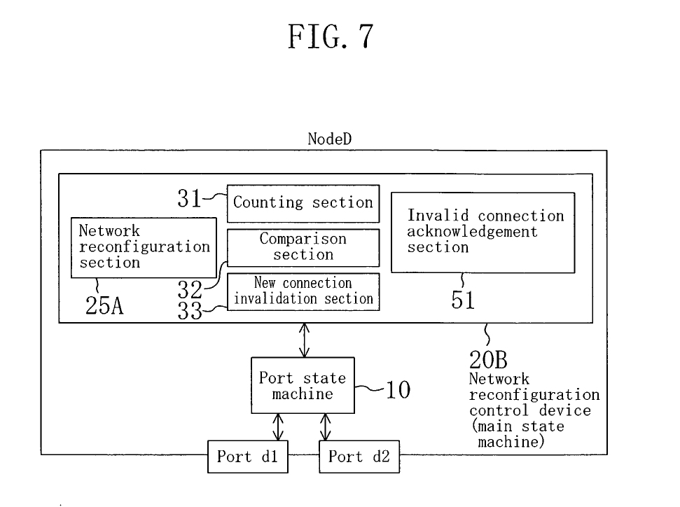

FIG. 7 is a block diagram illustrating an example of a configuration of a network reconfiguration control device 20B of the second embodiment.

As illustrated in FIG. 7, the network reconfiguration control device 20B of the present embodiment further includes an invalid connection acknowledgement section 51, in addition to the elements included in the network reconfiguration control device 20A illustrated in FIG. 1. Note that those elements that are already shown in FIG. 1 will be denoted by the same reference numerals and will not be further described below.

The invalid connection acknowledgement section 51 (corresponding to “invalid connection acknowledgement means”) acknowledges a node that has been invalidated by the new connection invalidation section 33 in step ST15 as described above in the first embodiment (corresponding to “invalid connection acknowledgement step”).

FIG. 8 is a flow chart illustrating an operation of the node D according to the present embodiment. In the flow chart of FIG. 8, step ST61 and step ST62, which are required for the operation of the invalid connection acknowledgement section 51 and the new connection invalidation section 33, are inserted before step ST11 in the flow chart of FIG. 2. Note that steps as those that are already described with reference to the flow chart of FIG. 2 will not be further described below.

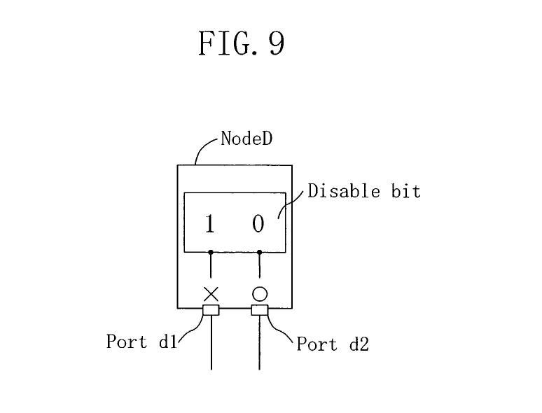

First, in a state where the entire network 1 is stable as illustrated in FIG. 3A, with the configuration of the network having been completed, the process proceeds to step ST61. In step ST61, upon invalidation of the newly-connected node F in step ST15 as described above, the counting section 31 starts measuring an amount of time (corresponding to “first amount of time”), and the invalid connection acknowledgement section 51 acknowledges the invalidated node F. Specifically, the invalidated node F is acknowledged by referencing the disable bits of the register of the IEEE1394 standard in which “1 ”is stored for the invalidated port d1 of the node D and “0” is stored for the valid port d2 of the node D, as illustrated in FIG. 9.

Then, the comparison section 32 compares the first amount of time being measured by the counting section 31 with a predetermined amount of time (corresponding to “first predetermined amount of time) so as to determine whether or not the amount of time being measured exceeds the predetermined amount of time. The process proceeds to step ST62 if the predetermined amount of time is exceeded, and to step ST11 otherwise. Thereafter, the subsequent steps are performed as described above. Note that if there is no node that is invalidated in step ST15 as described above, the amount of time is not measured, and thus can never exceed the predetermined amount of time. In such a case, the process proceeds to step ST11, of course.

Then, in step ST62, the new connection invalidation section 33 re-validates the node F, which has been acknowledged by the invalid connection acknowledgement section 51. Specifically, with the port d1 for the invalidated node F having been disabled, the node F is re-validated by canceling the disabled state of the port d1 by resetting the port state machine 10, for example. Then, the process proceeds to step ST11. Thereafter, the subsequent steps are performed as described above.

As described above, a newly-connected node that is once invalidated is acknowledged so that the node can later be re-validated. Therefore, a currently invalid network can be acknowledged easily, and it is possible again to reconfigure the network including the newly-connected node. This is advantageous in a case where the problem of the newly-connected node is later eliminated, whereby the node is again ready to be connected and the network reconfiguration process can be performed again.

Note that the description above has been directed to a case where step ST61 and step ST62, which are required for the operation of the invalid connection acknowledgement section 51 and the new connection invalidation section 33, are inserted before step ST11 in the flow chart of FIG. 2. However, the present embodiment is not limited thereto, and step ST61 and step ST62 may alternatively be inserted, as described above, before step ST11 in the flow chart of FIG. 4.

Moreover, the description above has been directed to re-validating a node that has once been invalidated in a case where the network reconfiguration process is performed based on the number of times counted by the counting section 31. However, also in a case where the network reconfiguration process is performed based on the amount of time measured by the counting section 31, as described above in the first embodiment with reference to FIG. 5 and FIG. 6, a node that has once been invalidated can be revalidated as described above by performing step ST61 and step ST62 before step ST11.

Moreover, while the various embodiments above are all directed to a case where a new node is connected to a network that includes two nodes, the present invention can be carried out also in cases where a new node is connected to a network that includes only one node or three or more nodes.

What is claimed is:

1. A network reconfiguration control device, comprising:
reconfiguration means for, when a new node is connected to a first network including one or more nodes, configuring a second network by performing a network reconfiguration process of acknowledging the new node;
completion detection means for detecting whether or not the configuration of the second network has been completed;
counting means for keeping track of predetermined information regarding the network reconfiguration process performed by the reconfiguration means;
comparison means for comparing the predetermined information kept track of by the counting means with a predetermined reference when the completion of the configuration of the second network is not detected by the completion detection means; and
new connection invalidation means for invalidating the newly-connected node based on the comparison result from the comparison means,
wherein the reconfiguration means further performs the network reconfiguration process based on the comparison result from the comparison means.

2. The network reconfiguration control device of claim 1, wherein:
the counting means keeps track of the predetermined information by counting the number of times the network reconfiguration process is performed by the reconfiguration means;
the comparison means compares the number of times counted by the counting means with a predetermined number of times as the predetermined reference;
the new connection invalidation means invalidates the newly-connected node when the number of times counted by the counting means exceeds the predetermined number of times; and
the reconfiguration means further performs the network reconfiguration process when the number of times counted by the counting means does not exceed the predetermined number of times.

3. The network reconfiguration control device of claim 2, wherein:
the network reconfiguration control device further comprises invalid connection acknowledgement means for acknowledging the node that has been invalidated by the new connection invalidation means;
the counting means measures a first amount of time from the invalidation of the node by the new connection invalidation means;
the comparison means further compares the first amount of time measured by the counting means with a first predetermined amount of time; and
the new connection invalidation means re-validates the node that has been acknowledged by the invalid connection acknowledgement means when the first amount of time measured by the counting means exceeds the first predetermined amount of time.

4. The network reconfiguration control device of claim 3, wherein the number of times counted by the counting means is the number of times the network reconfiguration process is performed within a predetermined amount of time.

5. The network reconfiguration control device of claim 2, wherein the reconfiguration means further performs the network reconfiguration process not only when the number of times counted by the counting means does not exceed the predetermined number of times, but also after the node has been invalidated by the new connection invalidation means.

6. The network reconfiguration control device of claim 5, wherein:
the network reconfiguration control device further comprises invalid connection acknowledgement means for acknowledging the node that has been invalidated by the new connection invalidation means;
the counting means measures a first amount of time from the invalidation of the node by the new connection invalidation means;
the comparison means further compares the first amount of time measured by the counting means with a first predetermined amount of time; and
the new connection invalidation means re-validates the node that has been acknowledged by the invalid connection acknowledgement means when the first amount of time measured by the counting means exceeds the first predetermined amount of time.

7. The network reconfiguration control device of claim 6, wherein the number of times counted by the counting means is the number of times the network reconfiguration process is performed within a predetermined amount of time.

8. The network reconfiguration control device of claim 1, wherein the network reconfiguration process includes a series of operations of bus initialization, tree identification and self-ID acknowledgement.

9. The network reconfiguration control device of claim 1, wherein the new connection invalidation means invalidates the newly-connected node by invalidating a port for the newly-connected node.

10. The network reconfiguration control device of claim 1, wherein:
the counting means keeps track of the predetermined information by measuring a second amount of time from the initiation of the network reconfiguration process by the reconfiguration means;
the comparison means compares the second amount of time measured by the counting means with a second predetermined amount of time as the predetermined reference;
the new connection invalidation means invalidates the newly-connected node when the second amount of time measured by the counting means exceeds the second predetermined amount of time; and
the reconfiguration means further performs the network reconfiguration process when the second amount of time measured by the counting means does not exceed the second predetermined amount of time.

11. The network reconfiguration control device of claim 10, wherein:
the network reconfiguration control device further comprises invalid connection acknowledgement means for acknowledging the node that has been invalidated by the new connection invalidation means;
the counting means further measures a first amount of time from the invalidation of the node by the new connection invalidation means;
the comparison means further compares the first amount of time measured by the counting means with a first predetermined amount of time; and
the new connection invalidation means re-validates the node that has been acknowledged by the invalid connection acknowledgement means when the first amount of time measured by the counting means exceeds the first predetermined amount of time.

12. The network reconfiguration control device of claim 10, wherein the reconfiguration means further performs the network reconfiguration process not only when the second amount of time measured by the counting means does not exceed the second predetermined amount of time, but also after the node has been invalidated by the new connection invalidation means.

13. A network reconfiguration control method, comprising:
a reconfiguration step of, when a new node is connected to a first network including one or more nodes, configuring a second network by performing a network reconfiguration process of acknowledging the new node;
a completion detection step of detecting whether or not the configuration of the second network has been completed;
a counting step of keeping track of predetermined information regarding the network reconfiguration process performed in the reconfiguration step;
a comparison step of comparing the predetermined information kept track of in the counting step with a predetermined reference when the completion of the configuration of the second network is not detected in the completion detection step; and
a new connection invalidation step of invalidating the newly-connected node based on the comparison result from the comparison step,
wherein in the reconfiguration step, the network reconfiguration process is further performed based on the comparison result from the comparison step.

14. The network reconfiguration control method of claim 13, wherein:
in the counting step, the predetermined information is kept track of by counting the number of times the network reconfiguration process is performed in the reconfiguration step;
in the comparison step, the number of times counted in the counting step is compared with a predetermined number of times as the predetermined reference;
in the new connection invalidation step, the newly-connected node is invalidated when the number of times counted in the counting step exceeds the predetermined number of times; and
in the reconfiguration step, the network reconfiguration process is further performed when the number of times counted in the counting step does not exceed the predetermined number of times.

15. The network reconfiguration control method of claim 14, wherein:
the network reconfiguration control method further comprises an invalid connection acknowledgement step of acknowledging the node that has been invalidated in the new connection invalidation step;
in the counting step, a first amount of time from the invalidation of the node in the new connection invalidation step is measured;
in the comparison step, the first amount of time measured in the counting step is further compared with a first predetermined amount of time; and
the node that has been acknowledged in the invalid connection acknowledgement step is re-validated in the new connection invalidation step when the first amount of time measured in the counting step exceeds the first predetermined amount of time.

16. The network reconfiguration control method of claim 14, wherein in the reconfiguration step, the network reconfiguration process is further performed not only when the number of times counted in the counting step does not exceed the predetermined number of times, but also after the node has been invalidated in the new connection invalidation step.

17. The network reconfiguration control method of claim 13, wherein:
in the counting step, the predetermined information is kept track of by measuring a second amount of time from the initiation of the network reconfiguration process in the reconfiguration step;
in the comparison step, the second amount of time measured in the counting step is compared with a second predetermined amount of time as the predetermined reference;
in the new connection invalidation step, the newly-connected node is invalidated when the second amount of time measured in the counting step exceeds the second predetermined amount of time; and
in the reconfiguration step, the network reconfiguration process is further performed when the second amount of time measured in the counting step does not exceed the second predetermined amount of time.

18. The network reconfiguration control method of claim 17, wherein:
the network reconfiguration control method further comprises an invalid connection acknowledgement step of acknowledging the node that has been invalidated in the new connection invalidation step;
in the counting step, a first amount of time from the invalidation of the node in the new connection invalidation step is further measured;
in the comparison step, the first amount of time measured in the counting step is further compared with a first predetermined amount of time; and
the node that has been acknowledged in the invalid connection acknowledgement step is re-validated in the new connection invalidation step when the first amount of time measured in the counting step exceeds the first predetermined amount of time.

19. The network reconfiguration control method of claim 17, wherein in the reconfiguration step, the network reconfiguration process is further performed not only when the second amount of time measured in the counting step does not exceed the second predetermined amount of time, but also after the node has been invalidated in the new connection invalidation step.
